(19) United States
(12) Patent Application Publication
(10) Pub. No.: US 2021/0234953 A1
(43) Pub. Date: Jul. 29, 2021

(54) REMOTE RECORDING AND DATA REPORTING SYSTEMS AND METHODS

(71) Applicant: Lucrative Innovations, Inc., Indianapolis, IN (US)

(72) Inventors: Craig M. Bracken, Indianapolis, IN (US); Danny K. Woods, Brazil, IN (US)

(73) Assignee: Lucrative Innovations, Inc., Indianapolis, IN (US)

(21) Appl. No.: 16/972,371

(22) PCT Filed: Jun. 7, 2019
(86) PCT No.: PCT/US2019/036067

§ 371 Date: Dec. 4, 2020

Related U.S. Application Data
(60) Provisional application No. 62/681,994, filed on Jun. 7, 2018.

(51) Int. Cl. H04M 1/72421; G10L 15/00; H04W 4/90

(52) U.S. Cl. CPC H04M 1/72421; H04M 1/72469; H04W 4/90; G10L 15/00

(57) ABSTRACT

Remote recording and data reporting apparatuses and methods, such as for enhancing personal security, are disclosed. Embodiments include a data processor, a microphone configured to detect audio signals and provide the audio signals to the data processor, a memory module configured to store one or more personal security response operations, and a communications module configured to transmit a personal security alert. A personal security procedure includes receiving an initiation signal, enabling the microphone in response to the receiving of the initiation signal, and detecting a spoken keyword which initiates one of the one or more personal security response operations and initiates recording of subsequent audio signals. Embodiments further include transmitting the personal security alert to a remote device.

### FIELD

Embodiments of this disclosure relate generally to methods and systems for providing recordings of information, and more specifically to methods and systems for providing remote recording and data reporting as related to personal security.

### BACKGROUND

There are various devices on the market aimed at providing greater personal safety protection. For example, mobile applications such as Red Panic Button allow a user to send an emergency message via email or mobile text messaging. These emergency messages may include location information associated with the user device, and/or may include a pre-recorded audio message. The emergency message in this example is activated by the user actuating a button provided on a user interface within the mobile application. Similarly, portable GSM-enabled personal security devices may permit a user to send a position signal that can be traced using a web-based application. These personal security devices may include an “SOS” emergency button which may initiate a phone call to a pre-designated person or group of people.

However, the personal security solutions noted above include intrinsic shortcomings. In particular, a physical action by the user (e.g., a button press) is required to activate the device to execute an action responsive to a threat. Additionally, the amount and type of information provided by the device may be insufficient for emergency responders to adequately or appropriately assess the reported threat. Absent more detailed information from the emergency message, and without the active participation of the user who is under threat, the emergency responders may not be able to respond in an adequate and/or timely manner.

### SUMMARY

Methods and systems are described which can permit a user to activate a recording device which will respond to a spoken word, phrase, or “keyword.” Detection of a spoken keyword can be configured to trigger a variety of responses to the activation. For example, when detection of a spoken keyword occurs, a word or phrase recognized by the system can determine an action which is taken. Detection of a spoken keyword can cause a recording device to record audio information received by the recording device. Similarly, GPS or other location data can be recorded responsive to detection of a spoken keyword.

A facility can be provided to a user via a user device which can allow a user to establish a set of contacts which may be associated with a spoken keyword. Contacts can include any type of communication identifier that may be used to deliver a message to a device associated with a contact. For example, an email address, a phone number, a messaging identifier (e.g., FACEBOOK Messenger ID), and/or other type of communication system identifier can be associated with a contact. A contact can also include an emergency responder such as a 911 service which can be configured using the 911 mapping system described herein.

A listening mode can be activated on a recording device which can cause a recording device to begin continuous monitoring of received audio for items in a list of a plurality of keywords. A listening mode can remain active until it is canceled by an action. For example, a user action can cancel a listening mode. A listening mode can be activated by a spoken command. A listening mode can also be activated by an action control in a user interface provided by a user device.

A server can be provided to perform communications between a plurality of recording devices and other devices which can be associated with target recipients of messages generated in response to a detection of a spoken keyword. A server can be connected to a recording device using a communications network, such as the internet. A server device can receive information from a recording device, and that information may be stored in hardware associated with a server device.

A web interface can be provided which can allow a user and/or authorized personnel to access information associated with a user. For example, a recording, contact information, images, physical description, etc. associated with a user can be accessed using a web browser interface provided by a server device which can access information of a user.

A recording device can be a general-use device such as a smartphone, laptop, or tablet computing device. A recording device can also be a purpose-built device that might be optimized for speech recognition and recording. Optionally, a recording device can be a device such as the AMAZON ECHO or GOOGLE HOME device.

### BRIEF DESCRIPTION OF THE DRAWINGS

Some of the figures shown herein may include dimensions or may have been created from scaled drawings. However, such dimensions, or the relative scaling within a figure, are merely presented by way of example and are not to be construed as limiting.

FIG. 1 is a block diagram of a system architecture of one embodiment of a remote recording and data reporting system.

FIG. 2 is a block diagram of a recording device of one embodiment of a remote recording and data reporting system.

FIG. 3 is a flowchart illustrative of the preparation of a recording device according to one embodiment of a remote recording and data reporting system.

FIG. 4 is a flowchart illustrative of the monitoring and response process according to one embodiment of a remote recording and data reporting system.

FIG. 5 is an exemplary user interface for activating a recording device according to one embodiment of a remote recording and data reporting system.

FIG. 6 is an exemplary user interface for selecting a keyword according to one embodiment of a remote recording and data reporting system.

FIG. 7 is an exemplary user interface for an active recording device according to one embodiment of a remote recording and data reporting system.

FIG. 8 is an exemplary user interface for setting up a recording device according to one embodiment of a remote recording and data reporting system.

FIG. 9A is an exemplary user interface for training for a keyword according to one embodiment of a remote recording and data reporting system, showing the user interface awaiting a user input.

FIG. 9B is an exemplary user interface for training for a keyword according to one embodiment of a remote recording and data reporting system, showing the user interface confirming a received user input.

FIG. 10 is an exemplary user interface for selecting a contact associated with a keyword according to one embodiment of a remote recording and data reporting system.

FIG. 11 is an exemplary user interface for composing a message associated with a keyword according to one embodiment of a remote recording and data reporting system.

FIG. 12 is an exemplary user interface for managing recordings according to one embodiment of a remote recording and data reporting system.

FIG. 13 is an exemplary user interface for creating profile information according to one embodiment of a remote recording and data reporting system.

FIG. 14 is an exemplary user interface for responding to a message according to one embodiment of a remote recording and data reporting system.

FIG. 15 is an exemplary user interface for viewing information associated with a message according to one embodiment of a remote recording and data reporting system.

FIG. 16 is an exemplary user interface for an emergency responder viewing information associated with an emergency alert according to one embodiment of a remote recording and data reporting system.

FIG. 17 is one embodiment of a personal security base device for use with a remote recording and data reporting system.

FIG. 18 is a block diagram of the personal security base device of FIG. 16.

FIG. 19 is an exemplary personal security pendant device which may be configured to communicate with the personal security base device and provide one or more functions according to some embodiments of the remote recording and data reporting system.

### DETAILED DESCRIPTION OF THE ILLUSTRATED EMBODIMENTS

Reference will now be made in detail to the present embodiments discussed herein. Examples are illustrated in the accompanying drawings, wherein like reference numerals refer to the like elements throughout. The embodiments are described below to explain the disclosed system and method by referring to the figures. It will nevertheless be understood that no limitation of the scope is thereby intended, such alterations and further modifications in the illustrated device, and such further applications of the principles as illustrated therein being contemplated as would normally occur to one skilled in the art to which the embodiments relate. As used herein, words importing the singular shall include the plural and vice versa unless specifically contraindicated.

A system is described which allows a voice-activated response to a spoken keyword. An action may be required to activate monitoring for a spoken keyword. For example, a user may be required to activate an application and may be required to take a specific action in order that monitoring for a spoken keyword is active, or enabled. If an activation action is not taken, a spoken keyword may not activate a response by a recording device.

In one embodiment, a recording device is a smartphone, while in other embodiments the recording device may be the Personal Security Base Device and/or the Personal Security Pendant Device described herein. An application, or “app,” installed on a smartphone may be used to provide a user interface which may be used to set up and activate monitoring for spoken keywords. For example, a user may be required to speak a predetermined phrase which may initiate monitoring. Monitoring may be implemented as a background process or “service” which may be operative on a recording device. Thus, continuous monitoring for detection of a spoken keyword may be accomplished regardless of whether an application, which could be used to activate monitoring, is active. A user may be able to select an action that enables a monitoring function. For example, a screen touch action, a key press, and/or a spoken phrase may be selected to activate monitoring. A time delay may be inserted between activation and a start of monitoring so a user is informed that monitoring is active.

In one example, wherein the recording device is a smartphone, a voice or touch-activated trigger event, such as speaking the phrase “protect me now,” enables audio monitoring, or a combination of audio monitoring and video recording, by the smartphone. The smartphone will then provide an indication that listening has begun, such as by outputting a sound or a vibration. Thereafter, the smartphone will continuously listen to the received audio for additional triggers, such as pre-defined keywords or phrases, which activate pre-defined actions. For example, a user may pre-define the key phrase “meatball sandwich,” when detected by the continuously recording smartphone to have been spoken by the user, to initiate a text message to a particular friend or emergency responder, wherein the text message content is pre-defined to read “please help me.” The text message may also include additional information, such geographic location tracking data representative of the location of the person in danger via the smartphone. At this point, the smartphone will begin recording the audio and/or video discreetly until stopped by the smartphone user, during and/or after which the recording(s) will be saved. In some embodiments, the smartphone, may automatically transmit the recording(s) to a remote server for storage. It should be understood that this represents only one example configuration of the systems and methods described herein and should not be considered limiting.

A recording device may record any information which is available to be recorded by the recording device, such as any information capable of being sensed by sensors equipped by the recording device. For example, many smartphones may include GPS modules, accelerometers, video capabilities, audio capabilities, pressure sensors, temperature sensors, and/or other sensory capabilities.

An interface is provided whereby a user may create a list of a plurality of spoken keywords. A voice recognition facility may be resident on a recording device, and the voice recognition facility may be trained to recognize and capture data from one or more particular users. For example, a user may “train” a voice recognition system to recognize a spoken keyword by the user speaking the keyword multiple times while the voice recognition system is enabled in a training mode.

An interface is provided whereby a user may identify actions which are to be taken responsive to detection of a spoken keyword. For example, a user may be able to select a keyword, and may provide a list of contacts which are associated with the keyword. Likewise, actions associated with a contact and a keyword may be defined by a user. For example, a contact might be sent a voice message, a Universal Resource Locator (URL), an audio file, an image, a video, text, and/or any other available information associated with a particular spoken keyword.

A system is provided which includes a server device. A server device may allow for communication between a recording device and a plurality of responder systems. A server device may obtain information from a recording device and/or other devices associated with a user. For example, a server may obtain audio information from a recording device when a spoken keyword is detected by a recording device. A server may route messages between a recording device and a responder system. For example, a server may direct a text message comprising a URL to a responder system, receive a message from a responder system which may cause a message to be delivered to a recording device, and/or create a message responsive to system conditions.

A network is provided which may connect components of the system. A network may comprise wired and/or wireless networks and may connect a recording device with other components of a system.

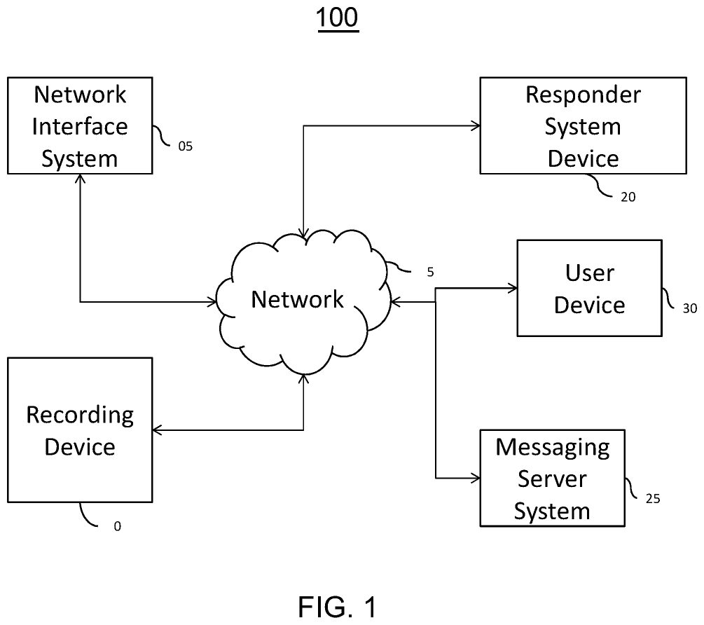

An exemplary system block diagram is provided in FIG. 1. The system 100 may comprise a network interface system 105, a recording device 110, a network 115, a responder system device 120, a messaging server system 125, and a user device 130. While a single responder system device 120, recording device 110, and user device 130 are depicted in FIG. 1, a plurality of such devices may be utilized.

The network interface system 105 allows any system which may access the network 115 to communicate with the messaging server system 125 (FIG. 1), for example, when the accessing system has been properly authenticated. The network interface 105 may comprise an Application Programming Interface (API) which may allow a network connected device to send a standard protocol request using for example a representational state transfer (REST) web service. For example, Hypertext Transfer Protocol (HTTP) request such as GET, PUT, POST, and DELETE may be used to send commands to and receive information from components of the system 100 (FIG. 1).

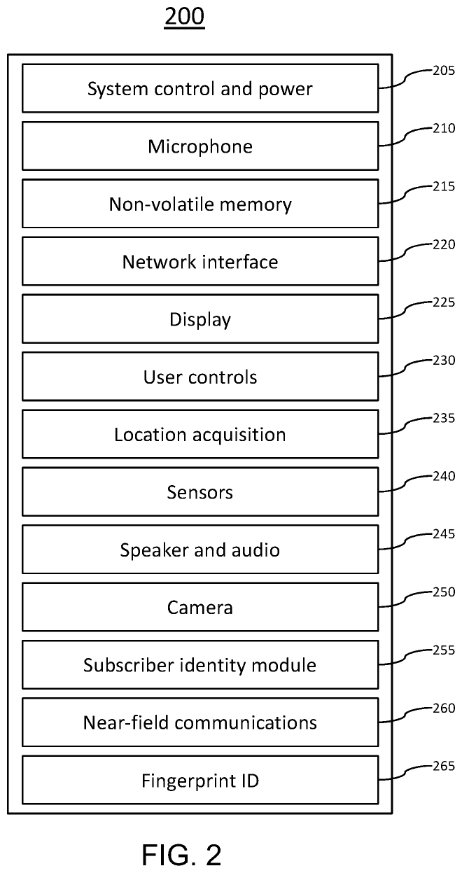

The recording device 110 allows for detection of audio and recording of information such as audio, GPS, and/or other data available to the recording device as further described herein with respect to FIG. 2. The recording device 110 may be implemented using any suitable computing device. For example, a microcontroller implementing the ARDUINO protocols might be used to implement the recording device 110, or a typical smartphone device might be used to implement the recording device 110. The recording device 110 includes a network interface which may or may not be accessible to elements of the system 100 such as the user device 130 and the network interface system 105. The recording device 110 may include various recording and detection functionalities as further described herein. For example, the recording system device 110 may implement a user interface, audio acquisition, location acquisition, speech and phrase detection, magnetic and gyroscopic sensing, temperature and pressure sensing, and local data storage. The recording device 110 may incorporate non-volatile memory which may be used to store unique identifiers associated with a recording device. A wired and/or wireless network protocol may be implemented to communicate between a plurality of elements of the system 100 and the recording device 110.

The network 115 may be a global public network of networks (e.g., the Internet) and/or may consist in whole or in part of one or more private networks and communicatively couples the network interface system 105, the recording device 110, the responder system device 120, the messaging server system 125, and the user device 130 with each other. The network 110 may include one or more wireless networks which may enable wireless communication between various elements of the system 100.

A remote server, such as messaging server system 125, may perform coordination between the network interface system 105, the recording device 110, the responder system device 120, and/or the user device 130. For example, the messaging server system 125 may route messages received from the recording device to a responder system device. The messaging server system 125 may receive a command from the network interface system 105, which may be sent responsively to a request from the user device 130. The messaging server system may determine commands and/or messages to be issued to a plurality of responder system devices, user devices, and recording devices based on a result of a message. The messaging server system 125 may provide a report and/or a notification to a user device regarding status of the system 100.

The messaging server system 125 may comprise a database which may be used to manage and route messages in the system 100 (FIG. 1). For example, the messaging server system 125 may maintain a database record associated with a plurality of responder system devices. For example, the messaging server system 125 may determine factors such as proximity, capabilities, and/or availability associated with a responder system device. The messaging server system 125 may provide a notification to a responder system device based on location information obtained from a recording device. The messaging server system 125 may also include memory for storing audio and/or video files recorded and transmitted to it by one or more recording devices 110.

The user device 130 may allow a user of the system 200 to access information and/or make requests of the system 200. For example, the network interface system 105 may provide a web interface which may allow a user of the user device 130 to select, create, and/or modify a message, a recording, a keyword, and/or other information associated with a recording device. The user device 130 may permit a user with sufficient access rights to view system status, responder systems available, historical information, system logs, etc., which may be used for systems administration.

A network interface system, a recording device, a responder system, a messaging server system, and/or a user device may be a desktop, portable, or tablet PC or MAC, a mobile phone, a smartphone, a PDA, a server system, a specialized communication terminal, a terminal connected to a mainframe, and/or any suitable communication hardware and/or system. For example, servers such as the POWEREDGE 2900 by DELL, or the BLADECENTERJS22 by IBM, or equivalent systems which might use an operating system such as Linux, WINDOWS XP, etc. might be used as a network interface system, messaging server system, or responder system. After being presented with the disclosure herein, one of ordinary skill in the relevant art will immediately realize that any viable computer systems or communication devices known in the art may be used as a network interface system, a responder system device, a recording device, a messaging server system, and/or a user device. Any suitable hardware and software components which are able to implement the required functionalities which are well known in the art may be used to implement as a network interface system, a recording device, a responder system device, a messaging server system, and/or a user device.

In an embodiment, a recording device may request and/or receive an application, or “app,” from a server such as the iPhone AppStore or Google Play Store, which may be operative on a recording device. Similarly, the network interface system 105 may provide content which may implement a “web app” which may operate in a browser functionality of a user device, a responder system, and/or a recording device.

As illustrated in FIG. 2, a recording device 200 may comprise a plurality of functionalities which may be implemented using hardware and/or software systems. A system control and power module 205 may serve to provide power to the other subsystems of the recording device 200. For example, battery power, charging, availability, connection management, system operations management, as well as speech detection and phrase recognition may be performed by the system control and power module 205. A microphone module 210 may consist of a plurality of transducers which may convert pressure waves (i.e., sound) to signals which may be processed and stored by the recording device 200. An exemplary standalone microphone module is the RE-SPEAKER 4 microphone array for RASPBERRY PI. A plurality of microphone devices may be used in order to perform functions such as ambient noise cancellation and direction sensing. A non-volatile memory module 215 may include flash memory which may be used for local storage and recoding of information. For example, NAND flash devices may be used as non-volatile memory.

A network interface 220 may provide for wired and wireless communications. For example, USB data connectivity may be implemented in the network interface 220. Similarly, Wi-Fi, 3G/4G phone connection, BLUETOOTH, and FM radio communications may be implemented in the network interface module 220. An exemplary standalone GPRS and WI-FI module is the LE910NAG, 4G+GPS shield for ARDUINO and RASPBERRY PI. A display module 225 may comprise a visual display and user interface component (e.g., touch screen). A visual display may be, for example, LCD, OLED, LED, etc. The display module 225 may comprise controls for back-lighting, and display management. In an embodiment, the display module 225 may comprise a plurality of indicator lights. A user control module 230 may comprise mechanical and/or optical transducers which may be used to obtain actions of a user. A location acquisition module 235 may comprise location functionality such as GPS, as incorporated in the LE910NAG previously described. A sensors module 240 may include sensors for humidity, temperature, gravity, gyroscopes, etc. as is well known in the art. A speaker and audio module 245 may comprise power amplifiers, speakers, and/or other audio output components. A camera module 250 may comprise a plurality of cameras. For example, the camera module 250 may incorporate a user-facing camera and one or more non user-facing cameras as per, for example, the IPHONE 7. A subscriber identity module (SIM) module 255 may include the hardware and software functionalities to identify a device and permit the recording device 200 to access a wireless phone network. A near-field communications (NFC) module 260 may permit the recording device 200 to communicate via near-field RF communications protocols. A fingerprint ID module 265 may allow the recording device 200 to perform biometric verification of a fingerprint.

Any suitable hardware as is well known in the art may be used to implement the various modules of the recording device 200. Any of the modules of the recording device 200 may be omitted as determined suitable for its intended purpose.

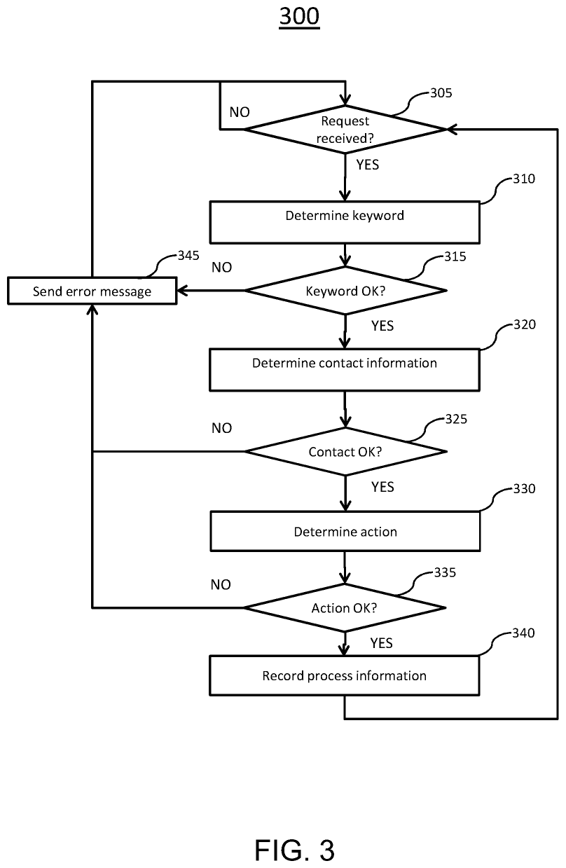

As illustrated in FIG. 3, a process 300 for commissioning a recording device is provided. The process 300 may be performed in whole or in part by any suitable element of the system 100 (FIG. 1). In at least one embodiment, the process 300 is operative on the recording device 110. In an embodiment, the process 300 is operative on the user device 130. A request to set up a recording device may originate from any device in the system 200. A request to set up a recording device may be originated by an action detected by a recording device.

In operation 305 (FIG. 3) a determination is made as to whether a request to set up a recording device is received. If it is determined in operation 305 that a request to set up a recording device is not received, control remains at operation 305, and process 300 continues. If it is determined in operation 305 that a request to set up a recording device is received, control is passed to operation 310, and process 300 continues.

The determination in operation 305 may be made using various criteria. In at least one embodiment, if a user activates a control of the recording device 110 (FIG. 1), it may be determined that a request to set up a recording device is received. For example, if a request is received at an address associated with the network interface system 105 from the user device 130 it may be determined that a request to set up a recording device is received. In an embodiment, a web browser functionality of the user device 130 may be used to access a web-based application provided by the network interface system 105, which may be used to perform any or all of the process 300. An authorization and/or verification process including security data may be required as part of a determination that a request to set up a recording device is received.

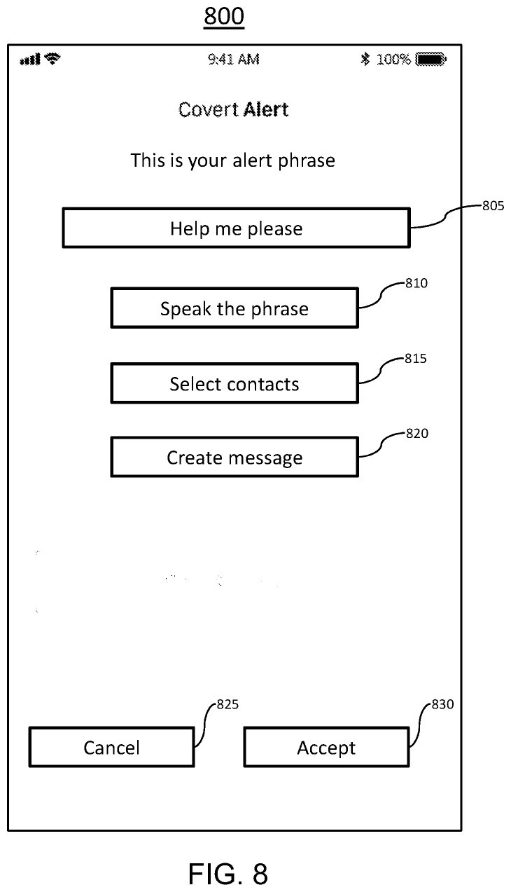

In operation 310 a keyword is determined. For example, a user interface (UI) such as that depicted in FIG. 8 may be provided to a user of a recording device or a user device. A keyword or key phrase may consist of any number of words and/or phonemes. In an embodiment, at least three utterances are required to establish a keyword. In some embodiments, a keyword may be required to be selected from a list of keywords. Control is passed to operation 315, and process 300 continues.

In operation 315, a determination is made as to whether a keyword is acceptable. If it is determined in operation 315 that a keyword is not acceptable, control is passed to operation 345, and process 300 continues. If it is determined in operation 305 a keyword is acceptable, control is passed to operation 320, and process 300 continues.

The determination in operation 320 may be made using various criteria. In at least one embodiment, a keyword length may be verified to determine whether a keyword is “OK,” or acceptable. A speech recognition process may be applied to determine if a keyword is acceptable. For example, a user may be required to speak a keyword a plurality of times, which may be measured by a speech recognition system, which may require that the keyword is correctly recognized a predetermined number of times to determine if a keyword is acceptable. Temporal and spectral analysis of a spoken keyword may be performed, recorded, and may be compared to a reference to determine if a keyword is acceptable. A keyword may be converted to text and may be compared to a dictionary of keywords which may be used to determine whether a keyword is acceptable. For example, if a keyword is in a list of blocked keywords due to factors such as ambiguity, frequency of use, etc., it may be determined that a keyword is not acceptable. In an embodiment, no verification of a keyword may be performed, and it may always be determined that a keyword is acceptable.

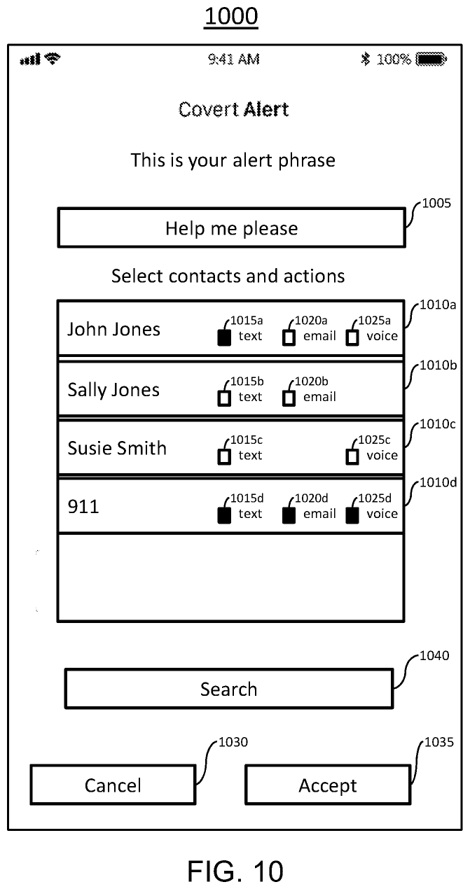

In operation 320, contact information is determined. For example, a UI such as that depicted in FIG. 10 may be provided to a user. A selection of contacts from a dictionary, such as a contacts dictionary typically accessible in a mobile phone, or email client contacts list may be provided to a user to determine contact information based on a selection by a user. A type of messaging which may be associated with a contact may be used to determine contact information. A generic emergency contact (e.g., 911) may be identified and may route a message to an emergency responder selected based on criteria such as geographic location of a recording device. Any suitable criteria may be used to determine contact information. Contact information may include any available communications system, such as email, instant messaging, voice communication, etc., as may be found in contact information of a person or entity. Control is passed to operation 325, and process 300 continues.

In operation 325 a determination is made as to whether a contact is “OK,” or acceptable. If it is determined in operation 325 that a contact is not acceptable, control is passed to operation 345 and process 300 continues. If it is determined in operation 325 that a contact is acceptable, control is passed to operation 330 and process 300 continues.

The determination in operation 325 may be made using various criteria. In at least one embodiment, if a test message is sent to a destination associated with a contact, and a response is received which indicates invalid contact information (e.g., email address not deliverable, etc.), it may be determined that a contact is not acceptable. In one embodiment, no verification of a contact is performed, and it may always be determined that a contact is acceptable. In another embodiment, if a contact is determined to be unacceptable, an error message 345 is provided, and control is passed back to operation 320 to, for example, permit a user to re-enter contact information.

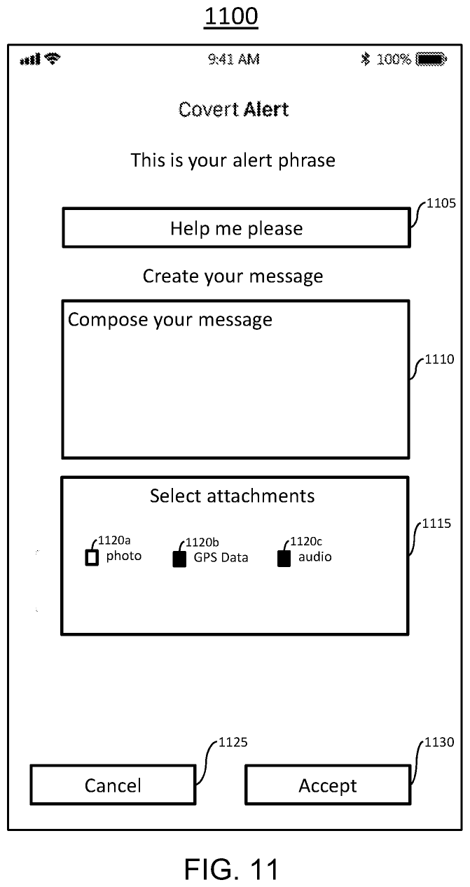

In operation 330, an action is determined. For example, a type of communication which is to be delivered to a contact may be determined, or content which is to be delivered to a contact may be determined. A UI, such as that depicted in FIG. 11, may be provided to a user in order to determine an action based on a user action. An action associated with a contact may be predetermined based on a type of contact. For example, if a contact is only associated with text messaging, an action associated with the contact may be required to be a text message, which may comprise a predetermined message. Similarly, if a contact is an emergency responder, a predetermined set of information may be provided to the contact. A user may customize an action based on a contact and/or a keyword. For example, a different keyword may cause a different action to be taken using the same contact as a first keyword. An action may comprise continuous recording of information acquired by a recording device. For example, audio, video, GPS, location, gyroscopic, and/or magnetic data available to a recording device may be recorded as part of an action. Control is passed to operation 335, and process 300 continues.

In operation 335, a determination is made as to whether an action is “OK,” or acceptable. If it is determined in operation 335 that an action is acceptable, control is passed to operation 340, and process 300 continues. If it is determined in operation 335 that an action is not acceptable, control is passed to operation 345, and process 300 continues. Alternatively, in some embodiments the control may be passed back to operation 330 if the action is deemed unacceptable so the user may re-enter a new action and again proceed to operation 335.

The determination in operation 335 may be made using various criteria. For example, if a contact is associated with a browser device and an action includes delivering a URL to the contact it may be determined that the action is acceptable. Similarly, if an action is associated with delivering an image and an image has not been selected by a user, it may be determined that an action is not acceptable. Any suitable criteria may be used to determine whether an action is acceptable.

In operation 340, process information is recorded. For example, a keyword, contacts, and actions associated with a keyword may be stored in memory of a recording device. Likewise, information of a user, a user device, a keyword, an action, a contact, and/or a recording device may be recorded in persistent storage associated with the messaging server system 125 (FIG. 1), the responder system device 120, and/or any suitable elements of the system 100. Control is passed to operation 305, and process 300 continues.

In operation 345, an error message is sent. An error message may be based on historical information of an error detected in the process 300. For example, if a keyword error is detected, a suitable message indicating the nature of the error may be provided in a UI to permit a user to correct the error. Likewise, if a contact error and/or an action error is detected, a message may be provided to a user to indicate a type of error and/or to suggest a corrective action. Information obtained via the process 300 may be recorded in persistent storage of any suitable element of the system 100 (FIG. 1). Control is passed to operation 305, and process 300 continues.

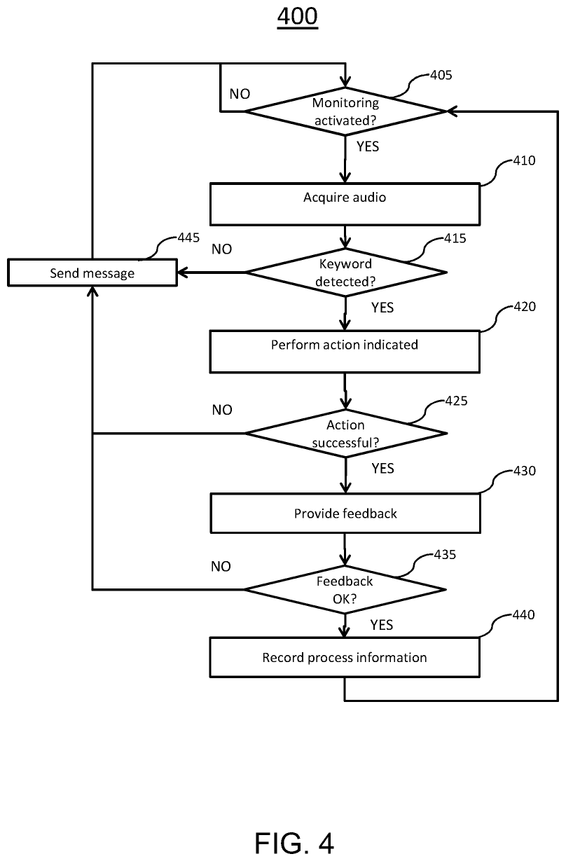

As illustrated in FIG. 4, a process 400 for activating a recording device is provided. The process 400 may be performed in whole or in part by any suitable element of the system 100 (FIG. 1). In at least one embodiment, the process 400 is operative on the recording device 110. A request to activate a recording device may originate from any suitable component of the system 100. A request to activate a recording device may be initiated by user action detected by a recording device.

In operation 405 (FIG. 4), a determination is made as to whether monitoring is activated. If it is determined in operation 405 that monitoring is not activated, control remains at operation 405, and process 400 continues. If it is determined in operation 405 that monitoring is activated, control is passed to operation 410, and process 400 continues.

The determination in operation 405 may be made using various criteria. In an embodiment it may be determined that monitoring is activated based on audio information received by a recording device. For example, if a keyword is detected by a recording device, it may be determined that monitoring is activated. If a user action, such as a key press or “swipe” gesture is detected, it may be determined that monitoring is activated.

In operation 410, audio may be acquired. Audio may be acquired using any suitable facility of a device of the system 100 (FIG. 1). In an embodiment, audio is acquired by the recording device 110 (FIG. 1). In an embodiment, audio may be acquired by a device associated with the recording device, such as an external microphone, wearable device, wirelessly connected device, etc., which can be connected via BLUETOOTH, WI-FI, or the like. Control is passed to operation 415, and process 400 continues.

In operation 415, a determination is made as to whether a keyword is detected. If it is determined in operation 415 that a keyword is detected, control is passed to operation 420, and process 400 continues. If it is determined in operation 415 that a keyword is not detected, control is passed to operation 445, and process 400 continues.

The determination in operation 415 may be made using various criteria. For example, real-time speech recognition software operative on the recording device 110 (FIG. 1) might compare received and decoded audio converted to text to a list of key phrases associated with the recording device. If a match is found in the list of key phrases to the text, it may be determined that a keyword is detected, or that a triggering event has occurred. A voiceprint of a received utterance may be compared to a stored voiceprint, and if a match is not detected, it may be determined that a keyword is not detected. Any suitable criteria may be used to determine whether a keyword is detected.

In operation 420, an indicated action is performed. For example, a message associated with a keyword may be delivered to an address indicated by a contact associated with a keyword. A recording process may be initiated by a recording device responsive to detection of a keyword. Any action which may be associated with a keyword may be performed. Control is passed to operation 425, and process 400 continues.

In operation 425, a determination is made as to whether an action is successful. If it is determined in operation 425 that an action is successful, control is passed to operation 430, and process 400 continues. If it is determined in operation 425 that an action is not successful, control is passed to operation 445, and process 400 continues. In some embodiments, an unsuccessful action passes control back to operation 420, wherein the process 400 continues by performing the action again. The system may be configured to retry performance of unsuccessful actions any particular number of times before control is passed to operation 445.

The determination in operation 425 may be made based on various criteria. For example, if a network error occurs, it may be determined that an action is not successful. If a message is successfully delivered to a contact associated with an action, it may be determined that an action was successful. If a confirmation message is received from a contact indicated by an action, it may be determined that an action was successful. If a recording device acknowledges that a recording has started, it may be determined that an action was successful. In an embodiment, it may always be determined that an action is successful.

In operation 430, feedback can be provided. Responsive to detection of a keyword, an audio message, a visual indicator, and/or a haptic signal may be generated. For example, if a keyword is detected an audio message selected by a user to be associated with a keyword may be played. A “push” notification message may be provided to a recording device. If an action succeeds or fails, a feedback response indicating success or failure may be provided. A status message may be provided to indicate that a recording is in progress. Control is passed to operation 435, and process 400 continues.

In operation 435, a determination is made as to whether feedback is “OK,” or acceptable. If it is determined in operation 435 that feedback is acceptable, control is passed to operation 440, and process 400 continues. If it is determined in operation 435 that feedback is not acceptable, control is passed to operation 445, and process 400 continues. In some embodiments, an unacceptable or unsuccessful feedback passes control back to operation 430, wherein the process 400 continues by providing the feedback again. The system may be configured to retry providing feedback any particular number of times before control is passed to operation 445.

The determination in operation 435 may be made based on various criteria. If a user acknowledges a feedback indicator, it may be determined that feedback is acceptable. For example, a user may acknowledge a feedback message with a spoken response, a key press, a “swipe” or “shake” gesture, etc. Likewise, a user may take an action which indicates that monitoring is to be cancelled. For example, a spoken keyword, a key press, etc. may be used to indicate that a false detection has occurred. Any suitable criteria may be used to determine that feedback is acceptable. In an embodiment, it may always be determined that feedback is acceptable.

In operation 440, process information is recorded. Detection of a keyword, actions, contacts, responses to an action, user actions, device status, and/or any information acquired via the process 400 may be recorded using any suitable persistent storage of any element of the system 100. Control is passed to operation 405, and process 400 continues.

In operation 445 a message is sent. For example, a status message may be delivered based on historical information of the process 400. A detection of a keyword may be indicated to a user device, a failure of an action may be indicated to the messaging server system 125 (FIG. 1), a cancellation of monitoring may be indicated to a recording device. A message may be sent to any element of the system 100 based on information acquired via the process 400. Information of the process 400 may be recorded. Control is passed to operation 405, and process 400 continues.

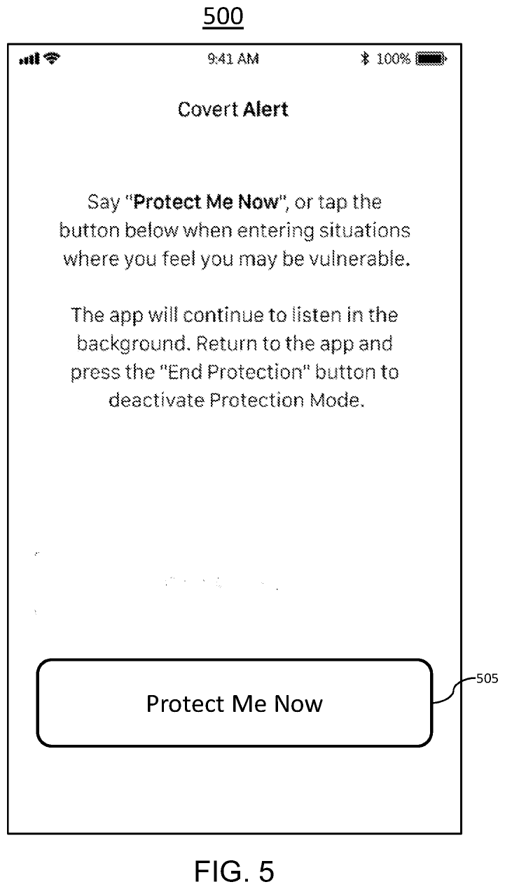

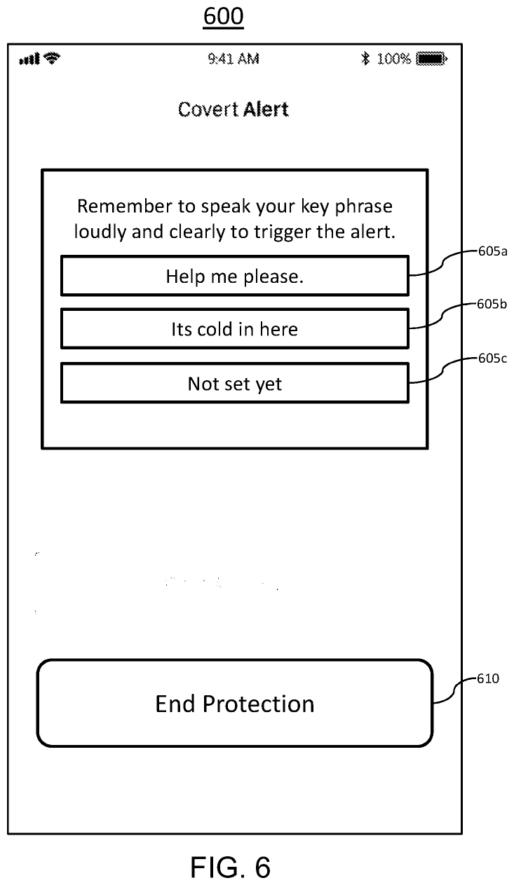

One embodiment of an exemplary UI 500 for activation of monitoring by a recording device is illustrated in FIG. 5. The UI 500 may be provided using a device such as the recording device 110 (FIG. 1). A monitoring activation control 505 is provided. The monitoring activation control 505 may cause monitoring of audio to be initiated when activated. Activation of the monitoring activation control 505 may cause a UI such as that depicted in FIG. 6 to be provided. An instruction provided in the UI 500 may indicate a spoken phrase which may be used to activate monitoring.

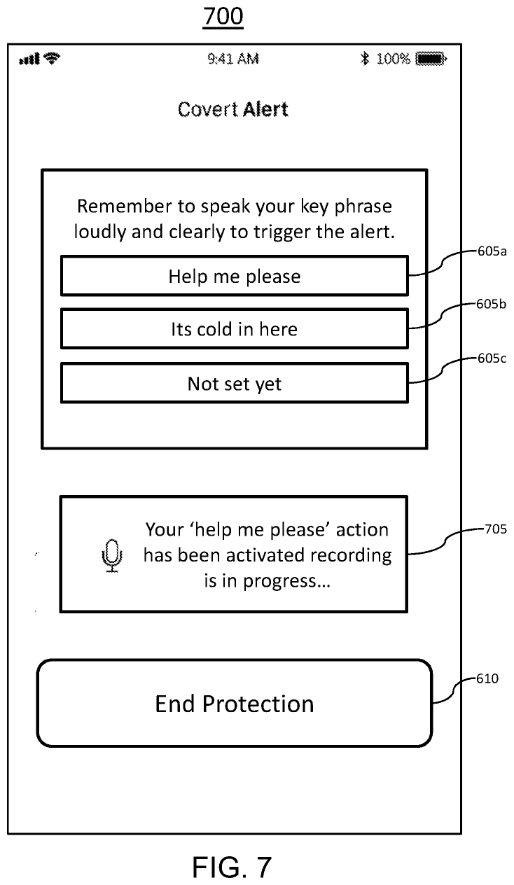

One embodiment of an exemplary UI 600 for managing keywords is illustrated in FIG. 6. The keyword management UI 600 may include keyword indicators 605a-605c and a monitoring cancellation control 610. The keyword indicators 605a-605c may be used to indicate a plurality of phrases associated with an action. An uninitialized keyword may be indicated as greyed out and/or as indicated by “Not set yet,” as shown by example keyword indicator 605c. Activation of a keyword indicator may cause a UI such as that depicted in FIG. 8 to be provided. Detection of a phrase indicated in the keyword indicator 605a may cause a UI such as that depicted in FIG. 7 to be provided. Activation of the monitoring cancellation control 610 may cancel keyword monitoring and may cause the UI 500 (FIG. 5) to be provided.

One embodiment of an exemplary UI 700 for indicating recording activation is illustrated in FIG. 7. The recording activation UI 600 may include the keyword indicators 605a-605c, the monitoring cancellation control 610, and action indicator 705. The functionality of the keyword indicators and monitoring cancellation control 610 has been previously described with respect to FIG. 6. The action indicator 705 may indicate a keyword which has been detected and a status of an action taken responsive to the keyword. Activation of the monitoring cancellation control 610 may cancel an action indicated in the action indicator 705.

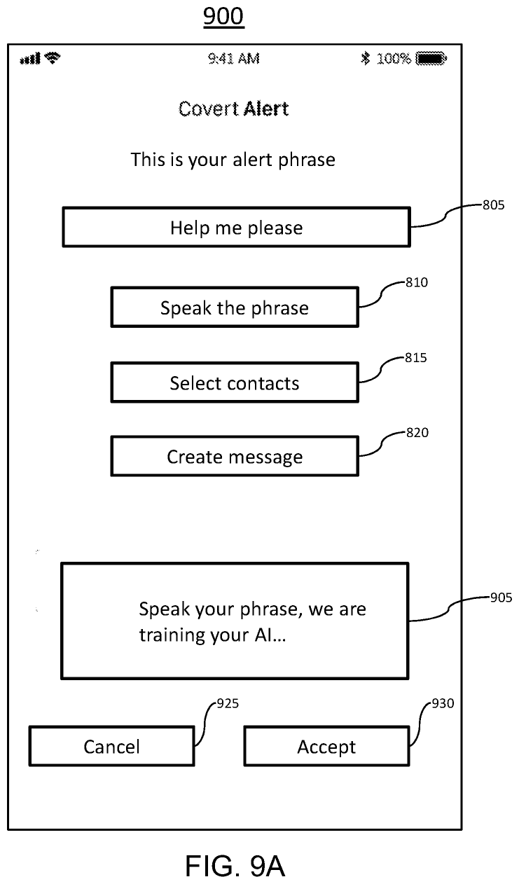

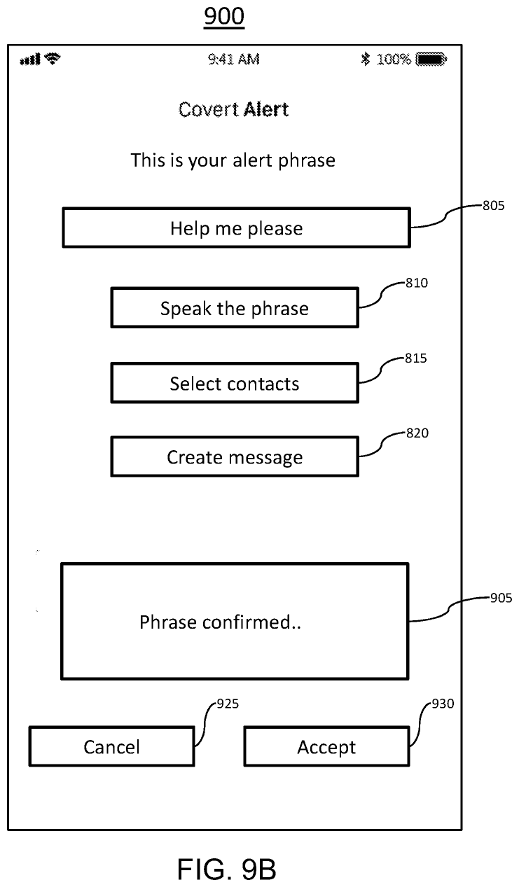

One embodiment of an exemplary UI 800 for managing a key phrase is illustrated in FIG. 8. The key phrase management UI 800 may include a keyword indicator 805, a phrase verification control 810, a contact selection control 815, a message composition control 820, a cancel control 825 and an accept control 830. The keyword indicator 805 may indicate a phrase which is to be detected in monitoring mode. Activation of the keyword indicator 805 may allow a user to edit content of a phrase and/or to speak a phrase which is to be converted to text. Activation of the phrase verification control 810 may cause a UI such as that depicted in FIG. 9A to be provided. Activation of the contact selection control 815 may cause a UI such as that depicted in FIG. 10 to be provided. Activation of the create message control 820 may cause a UI such as that depicted in FIG. 11 to be provided. Activation of the cancel control 825 may cause information obtained using the UI 800 to be discarded and cause the UI 600 (FIG. 6) to be provided. Activation of the accept control 830 may cause information obtained using the UI 800 to be recorded and cause the UI 600 (FIG. 6) to be provided.

One embodiment of an exemplary UI 900 for verifying a key phrase is illustrated in FIG. 9A. The key phrase verification UI 900 may include the keyword indicator 805, the phrase verification control 810, the contact selection control 815, the message composition control 820, a phrase detection indicator 905, a cancel control 925, and an accept control 930. The phrase detection indicator 905 may be used to indicate whether a phrase has been recorded. For example, if a user activates the phrase detection indicator 905, the UI 900 may change to show a message indicating that a recording device is verifying a spoken phrase in the phrase detection indicator 905 as shown in FIG. 9B. If a user does not speak a phrase, or if a phrase is not correctly detected, an indication may be provided in the phrase detection indicator 905. Activation of the cancel control 925 may cause information obtained using the UI 900 to be discarded and cause the UI 800 (FIG. 8) to be provided. Activation of the accept control 930 may cause information obtained using the UI 900 to be recorded and cause the UI 800 (FIG. 8) to be provided.

One embodiment of an exemplary UI 1000 for associating contacts with a key phrase is illustrated in FIG. 10. The contact management UI 1000 may include a keyword indicator 1005, contact information indicators 1010a-1010d, contact message selectors 1015, contact email selectors 1020, contact voice selectors 1025, contact search controls 1040, a cancel control 1030, and an accept control 1035. The keyword indicator 1005 may be used to indicate a keyword that is to be associated with a contact.

The contact information indicators 1010a-1010d may indicate information of a user contact associated with a keyword. For example, the contact indicator 1010a indicates the contact “John Jones.” The contact information indicators 1010 may include a plurality of selection controls, such as checkboxes or radio buttons. For example, the contact message selectors 1015a-1015d may be used to indicate that a text message is to be sent to the contact indicated by the respective contact information indicators 1010a-1010d. Absence of a contact message selector in a contact information indicator may indicate that a communication service indicated by the contact message selector is not associated with a contact indicated by a contact information indicator. The contact email selectors 1020a, 1020b, 1020d may be used to indicate that an email message is to be sent to a contact indicated by the respective contact information indicator. For example, selection of the contact email selector 1020b might cause an email to be sent to “Sally Jones” when the keyword indicated in the keyword indicator 1005 is detected. Likewise, the contact voice message indicators 1025a, 1025c, 1025d may be used to indicate that a voice message is to be delivered to a contact indicated in the respective contact information indicator when the keyword indicated in the keyword indicator 1005 is detected.

Activation of the cancel control 1030 may cause information acquired using the UI 1000 to be discarded and may cause the UI 800 (FIG. 8) to be provided. Activation of the accept control 1035 may cause information acquired using the UI 1000 to be stored and may cause the UI 800 (FIG. 8) to be provided. Activation of the search control 1040 may permit a user to enter search text in the search control 1040 and may cause a list of contacts matching the search text to be provided for selection. In an embodiment, a contact information indicator may be a generic contact such as “911,” which may utilize the 911 mapping system described below, as illustrated in the contact information indicator 1010d. A generic contact may cause a message to be directed to a destination selected by the messaging server system 125 based on information obtained from the recording device 110. For example, GPS coordinates associated with a recording device might be used to select an emergency responder, rather than area code associated with a user device or a cell phone tower “ping.” A contact indicator may not allow a user to modify any or all message indicators indicated in a contact indicator. For example, an emergency responder might have a fixed set of contact services which may not be modified by a user.

One embodiment of an exemplary UI 1100 for composing a message associated with a key phrase is illustrated in FIG. 11. The message management UI 1100 may include a keyword indicator 1105, message text indicator 1110, message attachment window 1115, attachment selection indicators 1120, a cancel control 1125, and an accept control 1130. The keyword indicator 1105 may be used to indicate a keyword that is to be associated with a message. The message text indicator 1110 may be used to provide text of a message which is to be provided when a keyword indicated by the keyword indicator 1105 is detected. The message attachment window 1115 may be used to indicate a plurality of attachments which are to be delivered to a contact when a message is delivered responsive to detection of a keyword indicated in the keyword indicator 1105. Attachment selection indicators 1120 may be used to select additional information which is to be provided to a contact associated with a keyword. The number and description of attachment indicators may depend on various factors. For example, if a recording device can acquire GPS data, or geomagnetic data, or if a profile picture has been selected by a user, an attachment selector indicating that such data may be provided may be indicated in the message attachment window 1115. As illustrated in the example of FIG. 11, the attachment selection indicator 1115a-1115c may be used to indicate that a photo, GPS data, audio recordings, and/or video recordings may be delivered as an attachment with a message when the key phrase “Help me please” is detected. Any number of attachment selection indicators may be provided in the message attachment window based on capabilities of devices found in the system 100 (FIG. 1).

Activation of the cancel control 1125 may cause information acquired using the UI 1100 to be discarded and may cause the UI 800 (FIG. 8) to be provided. Activation of the accept control 1130 may cause information acquired using the UI 1100 to be stored and may cause the UI 800 (FIG. 8) to be provided.

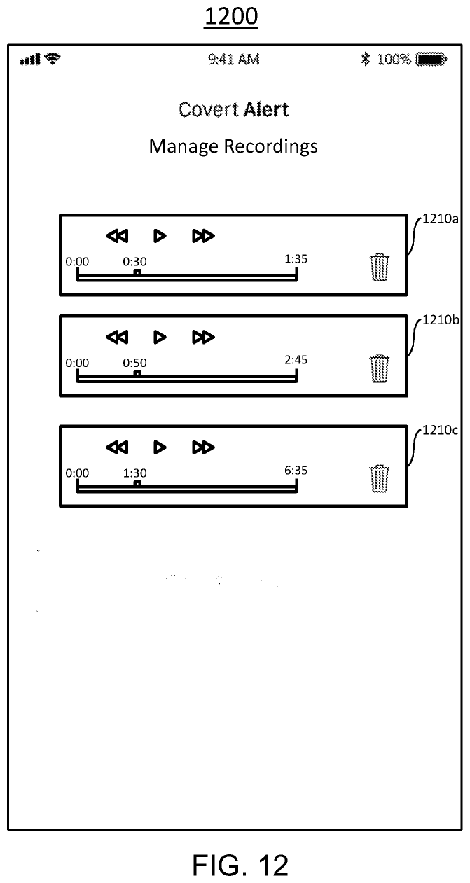

One embodiment of an exemplary UI 1200 for managing audio recordings is illustrated in FIG. 12. An action of a user may cause the UI 1200 to be provided. For example, a right-to-left or left-to-right “swipe” gesture in the UI 600 (FIG. 6) may cause the UI 1200 to be provided. The recording management UI 1200 may be provided using any suitable device such as the user device 130 (FIG. 1). The recording management UI 1200 may include recording indicators 1210a-1210c. The recording indicators 1210a-1210c may be used to control playback and deletion of stored recordings.

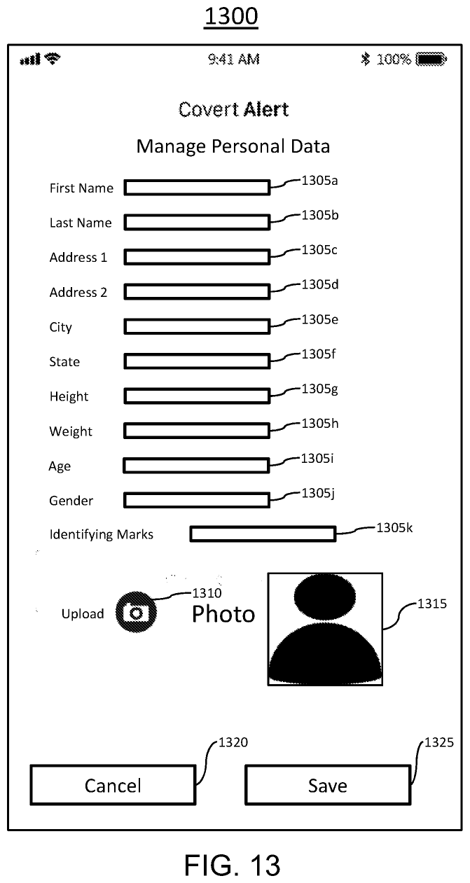

One embodiment of an exemplary UI 1300 for managing user information is illustrated in FIG. 13. The user information management UI 1300 may include user information indicator 1305a-1305k, photo upload control 1310, a photo window 1315, a cancel control 1320 and a save control 1325. The user information indicators 1305a-1305k may be used to provide information of a user. For example, first and last name, address, gender, and/or other descriptive information of a user may be provided using the user information controls 1305a-1305k. Activation of the photo upload control 1310 may cause a “pick list” to be provided whereby a user may select a photo that is to be uploaded. The photo window 1315 may indicate a current photo which has been uploaded using the photo upload control 1310. The cancel control 1320 may be used to discard any information obtained using the UI 1300. The save control 1325 may be used to store information obtained using the UI 1300. The UI 1300 may be provided using any suitable device of the system 100 (FIG. 1). For example, the UI 1300 may be provided using the user device 130 and/or the recording device 110.

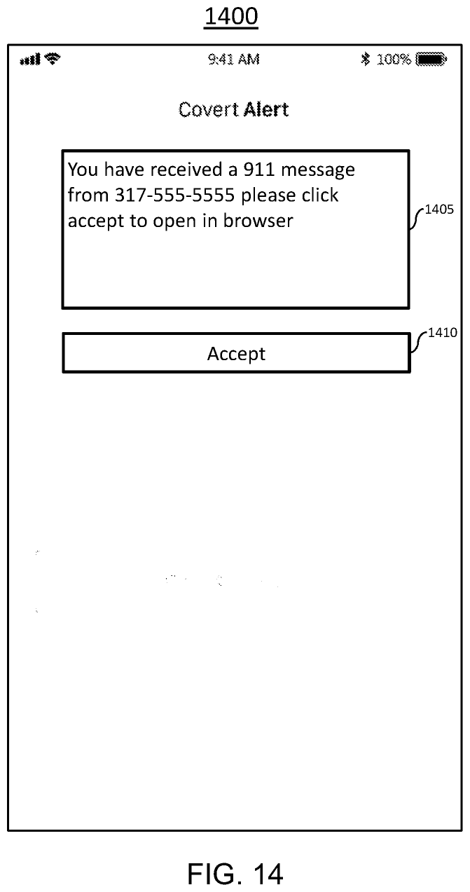

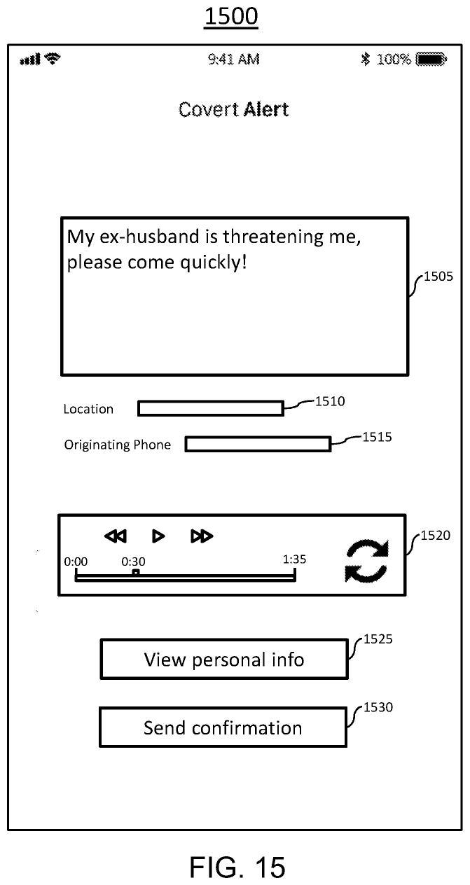

One embodiment of an exemplary UI 1400 for receiving a message is illustrated in FIG. 14. The responder message UI 1400 may include a user message window 1405 and a message acceptance control 1410. The responder message UI 1400 may be provided to any suitable element of the system 100 (FIG. 1). For example, the responder message UI 1400 may be provided to a browser functionality of the responder system device 120. The user message window 1405 may include information of a message composed by a user which is provided responsive to detection of a keyword. The message acceptance control 1410 may be used to indicate that a message has been accepted. Activation of the message acceptance control 1410 may cause a UI such as that depicted in FIG. 15 to be provided. Activation of the message acceptance control may cause a message to be delivered to the recording device 110 (FIG. 1).

One embodiment of an exemplary UI 1500 for retrieving information associated with a message is illustrated in FIG. 15. The responder information retrieval UI 1500 may include a user message window 1505, a location indicator 1510, a source indicator 1515, audio recording controls 1520, profile retrieval control 1525, and a confirmation message control 1530. The responder information retrieval UI 1500 may be provided to any suitable element of the system 100 (FIG. 1). For example, the responder information retrieval UI 1500 may be provided to a browser functionality of the responder system device 120. The user message window 1505 may include information of a message composed by a user which is provided responsive to detection of a keyword.

The location indicator 1510 may be used to indicate a location associated with a message. For example, a most recent GPS location acquired from a recording device may be indicated as an address and/or map location in the location indicator 1510. In an embodiment, the location indicator may comprise a map which indicates a sequence of location information acquired by a recording device. For example, if a substantial change (e.g., more than 20 meters in a one-minute interval) in location information is detected by a recording device, the location indicator 1510 might be presented as a map. A refresh control may be provided as a part of the location indicator 1510, which may retrieve additional location information from a recording device.

The originating phone indicator 1515 may be used to indicate information of a recording device which has initiated a message in response to a detected keyword. For example, a phone number, device ID, or other indicator of a source of a message may be provided in the originating phone number indicator 1515. If a recording device is not a mobile phone, an indicator of the device, such as “classroom 205, Marksburg, Elementary School” may be indicated in the originating phone indicator 1515.

The audio recording controls 1520 may allow play, pause, and scan capability for an audio recording associated with a message. A “refresh” control as indicated by the circular arrows may permit a recording to be refreshed from a source of the recording using the audio recording controls 1520. Activation of the profile retrieval control 1525 may cause information of a user such as that provided using the user information management UI 1300 (FIG. 13) to be provided. Activation of the confirmation message control 1530 may cause a message to be delivered to a suitable element of the system 100 which indicates that responder is taking an action in response to a message indicated by the user message indicator 1505.

911 Mapping System

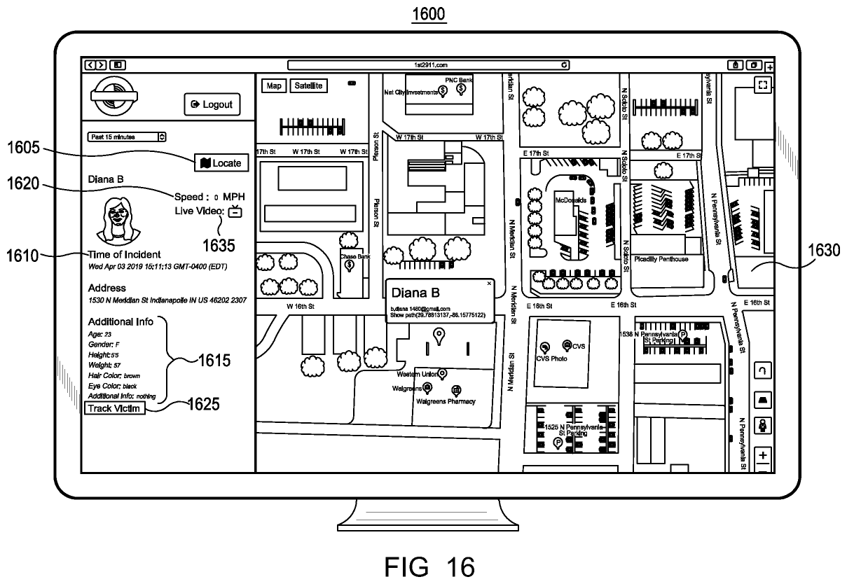

The 911 mapping system is a mobile or web-based application which can be configured to quickly connect victims with first responders. The 911 mapping system can include, for example, a remote server configured to host the mobile or web-based application and configured to communicate with personal security devices, such as smartphones and purpose-built personal security devices, to send and receive personal security alerts and the associated user data. If a user of the exemplary system, such as a victim of a threat or violence, actuates an alert through the exemplary system, first responders may be directly notified through the 911 mapping system. Depicted in FIG. 16 is an exemplary user interface 1600 which can be viewed by a first responder. In embodiments, a visual marker, which may include a flashing beacon and audio alert, is shown on the user interface 1600. When the police or first responding officer views the marker, such as by actuating a button via a user interface, the officer gains access to one or more of the location of the victim 1605, time of the incident 1610, and/or personal information 1615 of the victim such as age, gender, height, weight, hair color, eye color, a photo, and/or any additional information. If the victim is moving, the officer can view the speed 1620 in which the victim is moving. In some embodiments, the option is provided to track the victim via a tracking button 1625, and a tracking service interface 1630 is provided to the officer instructing the officer of the shortest available path to reach the victim. The directional service can be updated continuously based on the movement of victim. If the recording device associated with the victim provides live audio and/or video, the live audio and/or video can be viewed by the officer. The 911 mapping system can determine whether these audio and video features are being offered by the recording device and, if so, include links for the officer to view the content. In the illustrated example, the “live video” button 1635 may be actuated by the officer to view the live video.

Purpose-Built Personal Security Devices

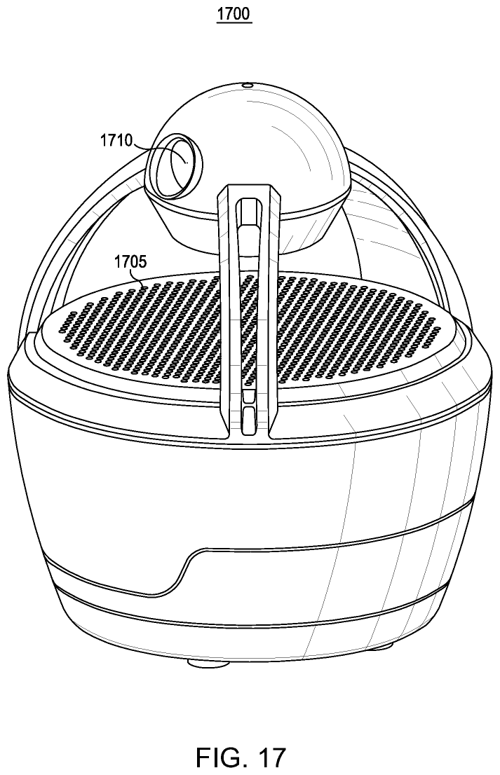

Depicted in FIG. 17 is a personal security base device 1700 which can be deployed within the remote recording and data reporting methods and systems described herein. The base device 1700 is a purpose-built device which can be optimized for speech recognition and recording, functioning within the personal security system as a recording device 110. The base device 1700 is a voice-activated security unit for enterprise applications which can capture audio and/or video during emergency situations taking place in the enterprise, such as a school, office, home, or the like. The base device 1700 can include a microphone 1705 enabled to listen for a particular spoken key phrase, and the base device 1700 can include a video camera 1710 which can be actuated to record by the microphone's 1705 detection of a spoken key phrase. The base device 1700 can then provide a live audio and/or video feed to emergency response personnel. The base device 1700 can be a desktop device powered by an external wall outlet and may include a battery backup.

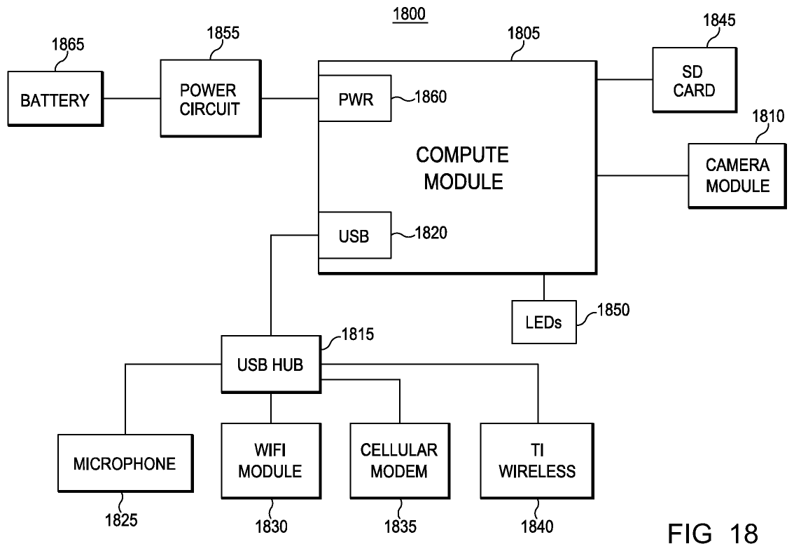

Depicted in FIG. 18 is a block diagram illustrating a base device 1800 having various components which can be incorporated into base device 1700. It should be understood that each and every component described herein may not be required for the base device 1800 to perform as a recording device 110, and certain components may be optional or may be substituted with one or more components which may provide the same or similar functionality.

An exemplary base device 1800 can include a compute module 1805. One example of a compute module 1805 is a RASPBERRY PI Compute Module 3, which may contain various sub-components such as a data processor, memory module, eMMC Flash, and supporting power circuitry. Base device 1800 may include a unique identification serial number to support multiple-device registration with the security system, for example, via the network interface system 105. Base device 1800 may also include stored credentials for authenticating the device for communications with the network interface system 105.

The base device 1800 may also include a video camera module 1810 capable of providing a live-stream video to a user across a wireless network. The camera module 1810 may connect to the compute module 1805, for example, using the standard camera interface provided by the RASPBERRY PI Compute Module 3. In some embodiments, the compute module 1805 interfaces with a USB hub 1815 connectable to the compute module 1805 via a USB port 1820. The USB hub 1815 can accept various inputs, such as a microphone 1825, a Wi-Fi module 1830, a cellular modem 1835, and/or a TI wireless module 1840. The microphone 1825, for example, includes the ability to receive audio to provide to the compute module 1805 for data processing and/or to store to a removable memory device, such as an SD card 1845 and/or for streaming as described herein. Video captured by the camera module 1810 may also be stored on the SD card 1845 and/or streamed. The microphone may be able to use the HLS communications protocol for streaming audio, and/or Dynamic Adaptive Streaming over HTTP (DASH). The Wi-Fi module 1830 may provide the ability for the base device 1800 to connect to a Wi-Fi access point or to connect directly to a client device, such as a smartphone, computer, or the like, via a Wi-Fi connection. The cellular modem 1835, for example, may provide the ability for the base device 1800 to connect to a cellular network. In this embodiment, the base device 1800 may also accept a SIM card for storing the network data required for connecting to a cellular network. The cellular modem 1835 may be utilized in place of, or as a backup to, the Wi-Fi module 1830 during base device 1800 operation. Further, base device 1800 may include a TI wireless module 1840 to support additional forms of wireless communications, such as BLUETOOTH, BLUETOOTH Low-Energy, RF, and the like.

The base device 1800 may include one or more status-indication LEDs 1850 which visually indicate a status of base device 1800, such as (1) “ready, AC powered,” (2) “ready, battery powered,” (3) “active streaming,” and/or (4) “alerting-secondary device.” The base device 1800 may include additional inputs, such as a USB interface (not shown) which is configured to connect to other devices or systems, such as a computer, if a wired connection facilitates initial commissioning of the base device 1800 into the security system.

Additionally, base device 1800 may include power circuitry 1855 for powering the base device 1800 through the power port 1860. In some embodiments, a battery backup 1865 is included to ensure the base device 1800 remains powered and enabled in the event of a power outage.

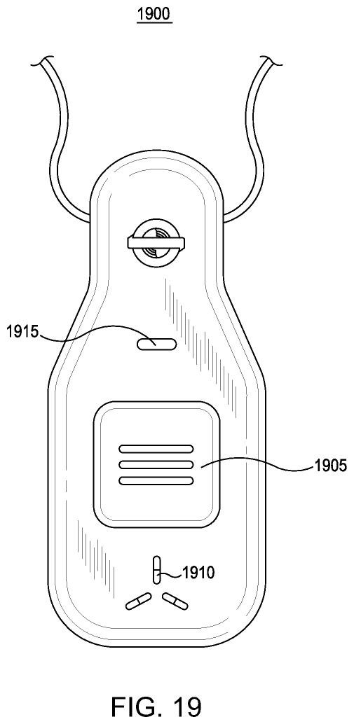

If the situation warrants, the base device 1700, 1800 can connect with a personal security pendant device that is wirelessly linked with the base device. Depicted in FIG. 19 is one exemplary pendant device 1900. The pendant device 1900 can include a small form factor permitting it to be carried with a user by hand, in a pocket, or worn around a user's neck via a lanyard. The pendant device 1900 activates the base device 1700, 1800 in the event the ambient noise level is too high to pick up or recognize a user's voice, or in situations that the user is positioned away from the device but may need emergency assistance.

The pendant device 1900 may include various components for connecting with a base device 1700, 1800, listening for spoken key phrases, and for transmitting audio and/or video streams to the base device 1700, 1800. In some embodiments, the pendant device 1900 may directly communicate with the network interface system 105 via a Wi-Fi or cellular connection or may do so through a wireless connection with a mobile device (e.g., a smartphone or tablet) or a computer system. Accordingly, the pendant device 1900 may at least include, for example, an audio and/or video transceiver, a microphone 1910, and a battery. Other components, such as a Wi-Fi or cellular module, may be included to support further wireless connectivity.

The pendant device 1900 may include one or more buttons to assist with activation of audio and/or video recording or commissioning/pairing of the pendant device 1900. For example, to pair the device, a user may press and hold the button 1905 until an audio or visual indication is received by a user, such as from status indicator LED 1915, indicating that a pairing mode has been activated. The user may then activate a pairing mode on the base device 1700, 1800 to initiate scanning for pendant devices. Once pairing has been completed, the LED indicator 1915 may output a light pattern indicating pairing has been completed.

To initiate recording, such as audio recording using the microphone 1910, pressing and holding the button 1905 can act to power on the pendant device 1900, establish or re-establish a wireless connection to the base device 1700, 1800, enable the microphone 1910, and stream audio data to the base device 1700, 1800. Thereafter, releasing the button can terminate audio streaming, disable the microphone, or terminate the wireless connection, respectively. In some embodiments, various functions are triggered by various numbers and/or durations of presses.

The base device, with or without connectivity to the pendant device, can communicate with the 911 mapping system. Specifically, the base device can be used to send emergency alerts to the 911 mapping system. When an alert is sent from the base device, it will appear on the 911 mapping system and permit the responding officer to view one or more of the device code, company name, room number in which the device is located, time of the incident, address, live streaming of audio and video, or other pertinent information provided by the personal security base device. Further, officers will be able to track the location of device if it is moving.

Using the methods and systems and apparatus described herein, a method and system for providing a message to a predetermined destination based on detection of a spoken keyword is described. A system in which functionality may be triggered by an activation action, followed by a monitoring and detection process is described. Activation of continuous monitoring may be accomplished using a user action such as a key press, or a spoken word and/or phrase. An acknowledgement may be delivered to a user when a monitoring function is activated. A monitoring function may be deactivated by a user action. For example, a “stop” word, phrase, gesture, and/or a UI actuation may cause a monitoring function to be terminated.

A plurality of keywords, which may consist of one or more utterances, can be identified. A corresponding destination for a message associated with a keyword can be defined. A spoken keyword may be verified based on utterances of a user. An action associated with a keyword may be verified by the system. An action associated with a keyword may be determined based on a destination associated with a keyword. A destination of a message associated with a keyword may be determined based on a type associated the destination and information acquired by a recording device which has detected a keyword.

A recording device is provided which may comprise sensors including audio, location, magnetic, RF, gyroscopic, temperature, pressure, and video data acquisition. When a monitoring function is activated, local storage may be used to record any or all available data. A speech detection and recognition capability may be resident on a recording device and/or may be obtained via a network. A recording device may have at least one network connection.

A network interface is provided which may permit a device with sufficient authorization to access information of any device connected to a network. A network, which may consist of one or more public and/or private networks, allows messages to be passed between devices using messaging protocols such as TCP/IP and HTTP and SMTP. A messaging server is provided which may allow messages to be routed from a recording device to user devices and/or responder devices.

If a keyword is detected, a message is originated by a recording device. A message may include prior recordings of audio, video, location, and/or other information acquired by a recording device while the recording device is actively monitoring. If a message is received by a responder system, information associated with a user may be provided. Information recorded by a recording device may be requested by a responder system. A responder system may receive continuous and/or on-demand updates of information which is recorded by a recording device.

The systems and methods described herein have been described using specific user interface components and methods which are well known in the art. However, no limitation is implied thereby. Any suitable components which may accomplish the functionality described herein and which are well known in the art may be used within the scope and spirit of the embodiments herein.

Any or all operations described herein may be implemented via one or more hardware components. However, the present invention is not limited to any specific implementation of an operation. For example, one or more operations discussed herein may be implemented via software executed on a device while others may be executed via a specific hardware device.

Further, according to an aspect of the embodiments, any combinations of the described features, functions, and/or operations can be provided.

The many features and advantages of the claimed invention are apparent from the detailed specification. Thus, it is intended by the appended claims to cover all such features and advantages of the claimed invention that fall within the true spirit and scope of the invention. Further, since numerous modifications and changes will readily occur to those skilled in the art, it is not desired to limit the invention to the exact construction and operation illustrated and described for the disclosed embodiments, and accordingly all suitable modifications and equivalents may be resorted to while still falling within the scope of the claimed invention. It will further be understood that the phrase “at least one of A, B, and C” may be used herein as an alternative expression that means “one or more of A, B, and C.” What is claimed is:

1. An apparatus for performing a personal security procedure, comprising:
(a) a data processor;
(b) a microphone operatively coupled to the data processor, wherein the microphone is configured to detect audio signals and provide the audio signals to the data processor;
(c) a memory module operatively coupled to the data processor, wherein the memory module is configured to store one or more personal security response operations, wherein at least one personal security response operation is defined by a user;
(d) a communications module operatively coupled to the data processor, wherein the communications module is configured to transmit a personal security alert defined by one of the personal security response operations;
wherein the personal security procedure includes:
(i) receiving an initiation signal,
(ii) enabling the microphone in response to the receiving of the initiation signal,
(iii) detecting a spoken keyword from the audio signals, wherein the spoken keyword initiates one of the one or more personal security response operations, and wherein the spoken keyword initiates recording of subsequent audio signals, and
(iv) transmitting the personal security alert defined by the one of the one or more personal security response operations to a remote device.

2. The apparatus of claim 1, wherein the initiation signal is provided by a tactile control when activated by the user.

3. The apparatus of claim 1, wherein the initiation signal is the detection by the microphone of a spoken audio cue.

4. The apparatus of claim 1, wherein the subsequent audio signals are stored in an audio file is stored in the memory module.

5. The apparatus of claim 1, further comprising:
a video camera operatively coupled to the data processor and configured to capture video signals;
wherein the initiation of the one of the one or more personal security response operations of the personal security procedure initiates recording of subsequent video signals.

6. The apparatus of claim 1, wherein the communications module is capable of at least one of Wi-Fi communications and cellular data communications.

7. The apparatus of claim 1, wherein the personal security procedure further includes, in response to receiving a termination signal, terminating the recording of the subsequent audio signals.

8. The apparatus of claim 7, wherein the personal security procedure further includes transmitting the recorded subsequent audio signals to a remote server for storage subsequent to the terminating of the recording of the subsequent audio signals.

9. The apparatus of claim 1, further comprising a GPS module, wherein the personal security alert includes geographic location data about the apparatus collected via the GPS module.

10. The apparatus of claim 1, wherein the recording of the subsequent audio signals is provided to the remote device in continuous real time.

11. A system, comprising:
(a) a personal security device, including
(i) a data processor having a memory storing a personal security response procedure, wherein the personal security response procedure defines an alert message and a trigger event,
(ii) a microphone operatively coupled to the data processor and configured to receive audio signals, wherein the microphone is configured to detect the trigger event from the audio signals, wherein the microphone records the subsequent audio upon detection of the trigger event,
(iii) a wireless transmitter operatively coupled to the data processor, wherein the wireless transmitter is configured to transmit the alert message upon detection of the trigger event, wherein the alert message includes a geographic location associated with the personal security device, and
(b) a remote server hosting a security monitoring application, wherein the remote server is configured to communicate with the wireless transmitter and is configured to receive the alert message, and wherein the security monitoring application is configured to display the alert message to a user through a graphical user interface.

12. The system of claim 11, wherein the personal security response procedure further defines a plurality of contact users, wherein at least one of the plurality of contact users is correlated with the alert message and the trigger event, wherein the wireless transmitter transmits the alert message to the correlated contact user upon detecting the trigger event.

13. The system of claim 11, wherein a portion of the subsequent audio is compiled into an audio file and is stored in the memory.

14. The system of claim 11, wherein a portion of the subsequent audio is compiled into an audio file and transmitted to and stored within a remote database.

15. The system of claim 11, wherein the personal security device further includes a video camera operatively coupled to the data processor and configured to capture video signals, wherein the video camera records the subsequent video upon detection of the trigger event.

16. The system of claim 15, wherein a portion of the subsequent video is compiled into a video file and is stored in the memory.

17. The system of claim 15, wherein the subsequent audio recorded by the microphone is streamed by the wireless transmitter to the remote server for real-time viewing via the security monitoring application.

18. A method of providing a personal security alert, comprising the steps of:
(a) receiving an initiation signal;
(b) in response to the receiving of the initiation signal enabling a microphone and receiving audio signals from the microphone;
(c) detecting a triggering event from the audio signals;
(d) upon detecting the triggering event, initiating a personal security response operation, wherein the personal security response operation defines event data pertaining to
(i) the triggering event,
(ii) an alert message to transmit in response to detecting the triggering event, and
(iii) one or more contacts to transmit the alert to in response to detecting the triggering event;
(e) signals upon detecting the triggering event, initiating a recording of the subsequent audio;
(f) composing the alert message defined by the event data; and
(g) transmitting the alert message to the one or more contacts defined by the event data.

19. The method of claim 18, further comprising:
(h) providing upon detecting of the triggering event a real-time audio feed of the recording of the subsequent audio to the one or more contacts defined by the event data.

20. The method of claim 18, further comprising:
(h) terminating the recording of the subsequent audio upon detecting of a second triggering event and compiling the subsequent audio into an audio file; and
(i) transmitting the audio file to a remote server for storage.
